(19) United States
(12) Patent Application Publication
(10) Pub. No.: US 2009/0210258 A1
(43) Pub. Date: Aug. 20, 2009

(54) INTERNET PROTOCOL DATA TRANSMISSION INSURANCE SYSTEM

(75) Inventors: Stephen C. Cardot, St. Paul, MN (US); Daryl R. Wilson, Burnsville, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: CLOUD COVER, LTD., St. Paul, MN (US)

(21) Appl. No.: 12/388,269

(22) Filed: Feb. 18, 2009

Related U.S. Application Data
(60) Provisional application No. 61/029,485, filed on Feb. 18, 2008.
(60) Provisional application No. 61/029,500, filed on Feb. 18, 2008.
(60) Provisional application No. 61/029,504, filed on Feb. 18, 2008.
(60) Provisional application No. 61/033,986, filed on Mar. 5, 2008.
(60) Provisional application No. 61/033,993, filed on Mar. 5, 2008.

(51) Int. Cl. G06Q 50/00; G06Q 40/00; G06F 21/00

(52) U.S. Cl. 705/4; 726/26

(57) ABSTRACT

An electronic transmission insurance method to insure electronic transmission between a first computer client and a second computer client. An electronic transmission identifier is associated with the electronic transmission. A claim is processed pursuant to the terms of the insurance policy if the network server does not receive the electronic transmission identifier from the second computer client indicating that the electronic transmission has been received by the second computer client.

This application claims priority to U.S. Provisional Applications Nos. 61/029,485, filed Feb. 18, 2008; 61/029,500, filed Feb. 18, 2008; 61/029,504, filed Feb. 18, 2008, 61/033,986 Mar. 5, 2008, and 61/033,993, filed Mar. 5, 2008, the contents of which are incorporated herein by reference.

### FIELD OF THE INVENTION

The invention relates generally to an insurance system. More particularly, the invention relates to an electronic transmission insurance system.

### BACKGROUND OF THE INVENTION

Stephen Cardot, one of the inventors identified in the current patent application, is also identified as an inventor in U.S. Pat. Nos. 6,922,720; 7,020,692; 7,246,157; and 7,349,954, that are each directed to the concept of insuring electronic transmission. The contents of these patents are incorporated herein by reference.

U.S. Pat. No. 6,922,720 includes independent claims that are directed to a system for providing transmission-coverage for transmission of data from a first remote client to a second remote client over a communications network. The system includes a computer server that is communicatively coupled to the first remote client and to the second remote client over the communications network.

The server includes a receiver, a charging mechanism and a logging mechanism. The receiver receives a request from the first remote client to cover transmission of a set of data between the first remote client and the second remote client. The request includes data specifying a selected transmission-coverage type and a selected transmission-coverage amount for the transmission

The charging mechanism operates, based on the request, to charge a transmission-coverage fee to an identified account for the selected transmission-coverage type having the selected transmission-coverage amount. The logging mechanism logs a status of the transmission into a logging data structure. The selected transmission-coverage type is bonding that provides a bonding coverage amount that is payable in the event the transmission fails.

U.S. Pat. No. 7,020,692 includes independent claims that are directed to a system for providing transmission-coverage for transmission of data from a first remote client to a second remote client over a communications network. The system includes a computer server communicatively coupled to the first remote client and to the second remote client over the communications network.

The server includes a receiver, a charging mechanism and a logging mechanism. The receiver receives a request to insure transmission of a set of data between the first client and the second client. The request includes data specifying a coverage amount for the insurance on the transmission.

The charging mechanism operates, based on the request, to charge an insurance premium fee to an identified account. The logging mechanism logs a status of the transmission into a logging data structure. The insurance provides that the coverage amount is payable in the event the transmission fails.

U.S. Pat. No. 7,246,157 includes independent claims that are directed to a method that includes providing selected transmission coverage for one or more transmissions of data that includes a first individual transmission across a network. In the event of failure of a transmission of data across the network, the coverage becomes payable as a selected coverage amount.

The method also includes logging data pertaining to the coverage for the one or more transmissions into a database structure. The method further includes allocating sufficient funds to back the selected coverage amount based, at least in part, upon information tracked in the database structure.

U.S. Pat. No. 7,349,954 includes independent claims that are directed to a computerized method executed in a server contains a processor and a memory. The method includes providing selected transmission coverage for one or more transmissions over a communications network. In the event of a failure of a transmission of data across the network, the coverage becomes payable as a selected coverage amount.

A completion status of the one or more transmissions is verified. This step includes determining whether each of the one or more transmissions was successfully transmitted and received. Data pertaining to the completion status is logged into a logging data structure in a database in the server.

A plurality of failed-transmission-coverage claims are received and authenticated based, at least in part, upon the data contained in the logging data structure. Thereafter, a claim report is generated based upon information tracked in the database.

### SUMMARY OF THE INVENTION

An embodiment of the invention is directed to an electronic transmission insurance method. The method includes associating a customer installation module with a first computer client. An electronic transmission is prepared on the first computer client that is addressed to a second computer client that is distinct from the first computer client. An electronic transmission identifier is generated with the customer installation module. The electronic transmission identifier is associated with the electronic transmission.

The electronic transmission is transmitted from the first computer client. The electronic transmission identifier is transmitted from the first computer client to a network server to indicate that the electronic transmission has been sent by the first computer client. An insurance policy relating to the electronic transmission is created.

The electronic transmission is received by the second computer client. A claim is processed pursuant to the terms of the insurance policy if the network server does not receive the electronic transmission identifier from the second computer client indicating that the electronic transmission has been received by the second computer client.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a flow diagram of a claims-inquiry network management system.

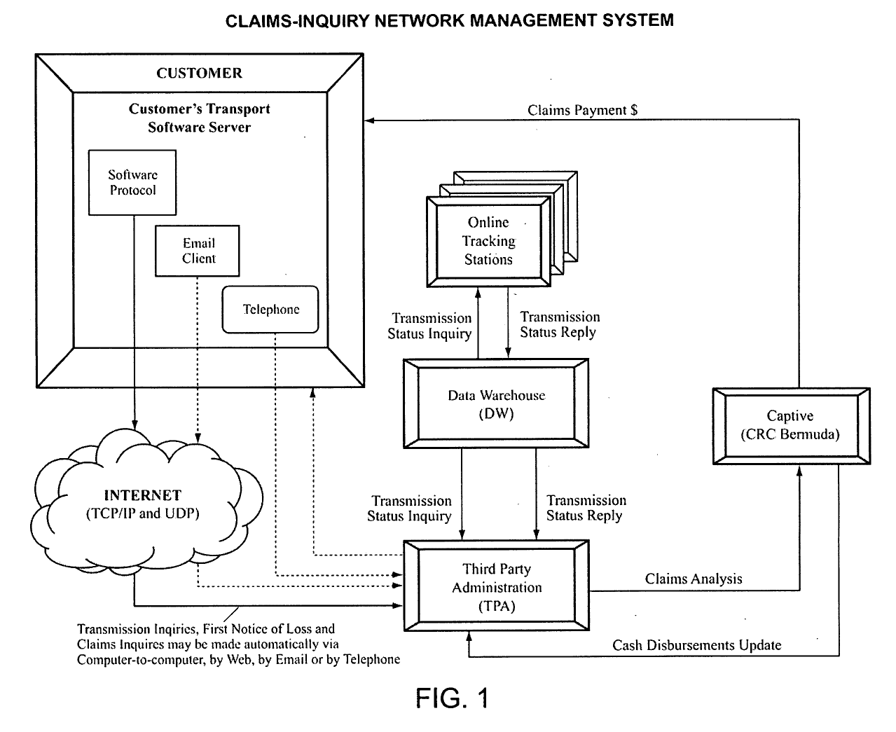

FIG. 2 is a flow diagram of an internet protocol data insuring/reinsurance process system.

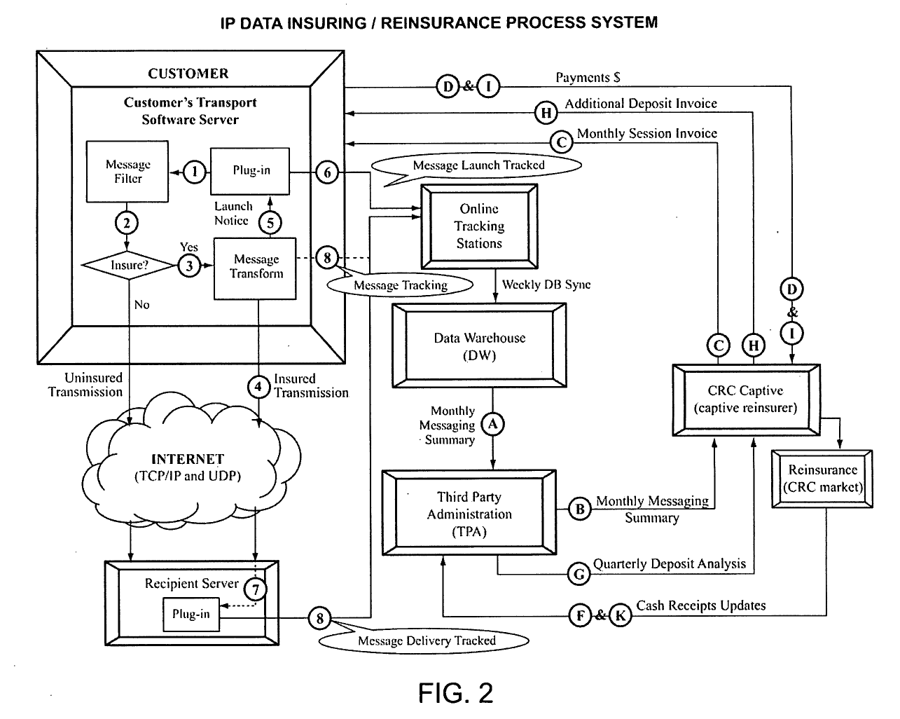

FIG. 3 is a flow diagram of an internet protocol data insurance tracking-logging system for claims inquiry management.

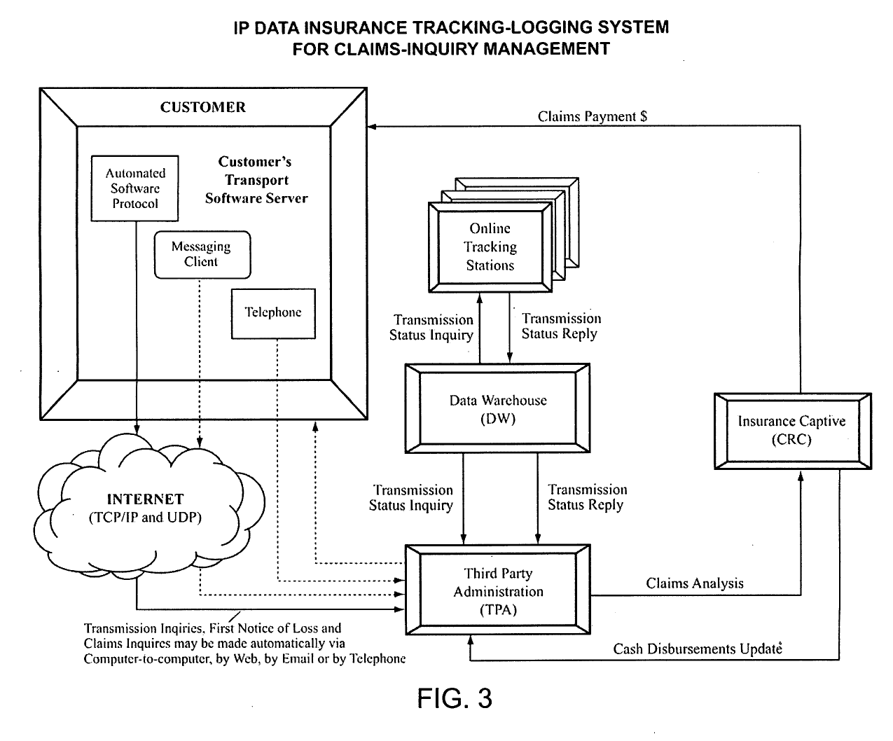

FIG. 4 is a flow diagram of an internet protocol data insurance tracking-logging insuring process.

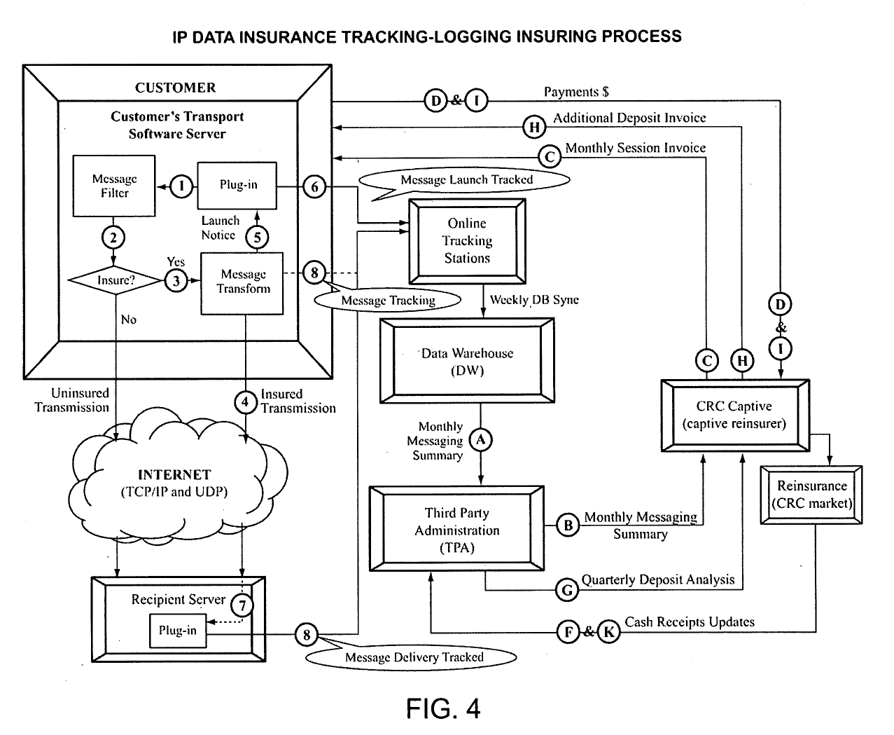

FIG. 5 is a flow diagram of an internet protocol data insurance tracking-logging for policy issuance processing network.

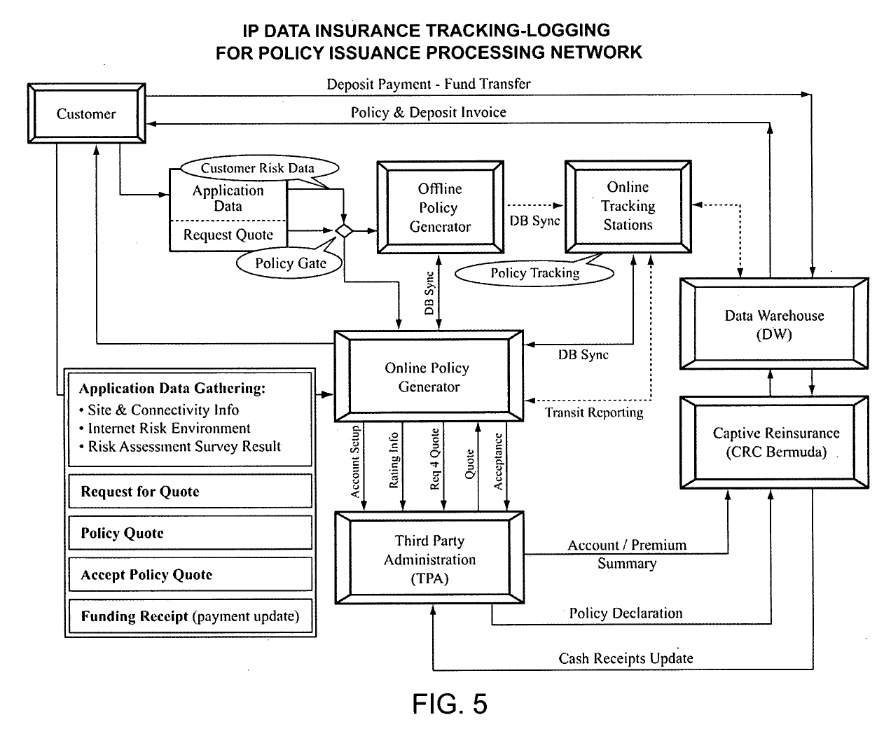

### DETAILED DESCRIPTION OF THE PREFERRED EMBODIMENTS

The electronic transmission insurance system is illustrated in the accompanying figures and described herein.

Once a policy is approved, it moves into the insuring phase of the policy lifecycle. The Policy Management System defines, generates and maintains issued insurance policies for internet protocol data transmission insurance. An ancillary function of this application system is configuration of the components required for the Customer Installation Module, which includes objects that are necessary for operation of the insuring function, which must reside at the customer's site.

Creating and servicing transmission insurance policies is one of the essential business functions of internet protocol Data Insurance. As stated above, it is the design objective of this process to be highly automated, providing ease for an agent to gathering a customer's policy requirements and generation of the policy. If the policy falls within approved guidelines, it will be automatically issued. Otherwise, the policy will be sent through the management approval cycle.

Policy creation is simple and consistent. Once a policy request is submitted and approved, the Policy Management System at internet protocol Data Insurance will use the information supplied by the Policy Generator to automatically generate the policy and to store that information in internet protocol Data Insurance's customer and policy databases. A parallel method will also be available to create and modify policy packages without using the Policy Generator.

To automatically create-underwrite a policy which requires at least one of the following steps: (1) determine and evaluate risk and develop rates and premiums (underwrite), (2) create the actual policy contract where no manuscripted terms are necessary for the client (accommodate variations by regulatory authority), (3) route policies for approval (if applicable), (4) track reinsure process for policies issued (if applicable), (5) create and maintain detailed policy information on each policy written (or pending) for the customer. The preceding steps may be done via the Policy Generator or done manually.

To assist in operating the data insuring process, data should be available on the system on pending, current and obsolete policies with effective date information and policy terms and limits for claims processing (“generational views”)

Additional steps in the process may include creating and maintaining regulatory business rules to comply with all statutory regulations, managing policy adjustments for conditions term and rate for the transmission and managing policy renewal functions and create statistical renewal reports.

It may be necessary to interface with other internet protocol Data Insurance systems such as; financial, sales management and data warehouse. The process may also include generating the Customer Installation Modules and the table information needed to install the package and, configure or update a customer's insurance product, validate insurance usage and track insurance usage and failures and create the client transmission bordereau.

Within the Policy creation-maintenance function the Policy system will need a policy generator. The Policy Generator is an automated tool that helps the customer define the policy that best suits their needs and calculates the premium for that policy. There will be two versions of this tool, the Corporate Policy Generator for high volume, high value corporate accounts and a Basic Policy Generator for use by the general public.

The front-end purpose of the policy generator is to guide a prospective or existing customer through the selection of the various coverage types, endorsements and options and to calculate the resultant premium(s). The policy generator will also collect key risk assessment information.

The back-end function of the policy generator is to provide definition input to the Policy Management System. Direct or indirect sales agents will use the more robust Corporate Policy Generator with large corporate customers. The occasional customer may use the Basic Policy Generator via the internet protocol Data Insurance website and tool bar instillation of the “insure” button to purchase coverage.

The internet protocol Data Insurance may initially develop the Corporate Policy Generator because the corporate market is the target for the product introduction. The policy generator may be a series of smart forms that collect and store customers' selections and responses to questions. These responses define their policy, endorsements and options in detail.

The Corporate Policy Generator allows the sales agent or Intelligent Agent (IA) to easily guide a corporate prospect or customer through the process of defining “data transmission-transaction insurance” and the policy underwriting requirements. This function may be accessed via a secure agent interface on the internet protocol Data Insurance partner's data center or via a website. The information will also input off-line collected data from a sales representative's computer and uploaded to a web site such as ipdatainsurance.net later after risk assessment and policy parameters are certified by risk-rate approval.

The agent will use the Policy Generator to guide the prospect/customer through choose coverage and endorsements, specifying insured value desired for each transmission, selecting level of service and delivery and reporting options, specifying insured transmission characteristics, select reporting and billing options and supplying key risk assessment information dependent upon coverage selections.

The Corporate Policy Generator will interface with the Policy Management System to generate a proposed policy and quote for the internet protocol Data Insurance approval cycle. Policy components include a Declarations, Insuring Agreement, terms of insurance coverage Inclusions versus Exclusions, Conditions, Definitions and policy Endorsements. It will also include an annual aggregate claims cap.

In addition to defining (proposed) Policy and calculating premiums, the Corporate Policy Generator will populate the Customer/Policy Database with the data necessary for the Policy Management System to generate the “Customer Installation Module.”

Once the master policy and corresponding risk assessment is identified and entered (by agent, IA), it is submitted for internet protocol Data Insurance analysis, risk rating (actuarial review) underwriting, pricing and approval.

The Policy Master component maintains the customer's Master Policy information. It must have the ability to handle licensees, Master Certificate's regulatory requirements, additional insureds endorsements conditions and exclusions, and all the sub-policies issuable under each master insurance declaration. It also maintains the information needed to construct (or reconstruct) the actual dynamic transmission policy.

Master Certificates are issued for a “group” policy. They are set up as an overall umbrella over a group of individual or sub policies. They have a master Aggregate Limit, which is used to limit the insurers overall liability. For example, the web site will operate under a Master Certificate. (It will even operate under more than one Master Certificate). All policies issued from the site will be issued under the Master Certificate. The groups that define a Master Certificate may need to be formed for a purpose other than insurance.

There are several methods of creating and maintaining this information. The information can be automatically created (or updated) from the policy agreement constructed by the sales representative using the Policy Generator. Once the policy agreement has been reached the Policy Generator can automatically update the Policy Master and the customer master. This information can also be automatically generated from the purchase of insurance from the web site.

The web site policies are policies issued under a Master Certificate. In addition, a graphical user interface (GUI) maintenance function may be required for corrections, additions, or unique (custom) policy creation.

Policy Master Information may be used to produce the legal insurance policy contract. Policy Master Tables may contain information on general policy information examples of which include client information, risk factors unusual client or policy features and other critical data.

General Information may include Policy Selections, Master Certificate ID (if applicable), Customer ID (i.e. customer identification), Policy ID (i.e. policy identification), Location where Contract was created (i.e. what regulatory authority applies), Location of Customer, Insurance Agent Broker or producer, Overall Policy limits and policy exclusions, Policy Effective Dates (i.e. time, and length of Policy that applies), Policy Aggregate Limits (the maximum amount the insurance company will pay for all claims against the policy, which may be set up by Customer, issued insurance Policy and Master Certificate.

The Actual Policy premium may include any policy premium discounts, or debits or credits to arrive at final rates, system calculated premium, risk rating and actuarial projections of loss, Insuring company (may be other, if licensed by IP Data Insurance) and Indicator to handle and resolve issue of duplicate filters within categories.

Coverage Specifics may include Coverage Types (objects of insurance or insured exposures), Policy Categories (type and class of transmission being insured), Endorsements (including manuscript terms and client specific endorsements), Policy Limits by transmission (or limits for classes of transmissions), Coverage Type if other than “claims made,” By Category (actuarial determinations based on characteristics of insured payload), What are the Category criteria? (requirements necessarily in place to insure), Limit ($) total aggregate amount of money payable under the policy for all claims), Delivery point (i.e. IP destination and Internet tracking & identification), Security options encryption protocols required or other payload protections, Specific Policy parameters terms and conditions under which coverage is valid, Specific Policy exclusions items and operations which are excluded from all insurance.

Following will be specific to a type of policy or general insuring requirements Beneficiaries or insureds entitled to collect monies from a claim under the contract, Policy risk factors and assumptions overall actuarial model modified by clients operations, line of business, and susceptibility to events giving rise to loss and potential claims, Will need information as to customer site, software and existing security protocols in order to produce Installation Package will be, Types of plug-in needed or downloaded to provide interoperatibility of systems, Insurance administrators ID for support and claims processing, Links to other services provided which may impact insuring requirements, Types of security modules purchased and interoperability with our modules, Pointers to the policy contract terminology construction tree—so policy contract can be printed and/or recreated or updated, Delivery point—server or user which is configured to issue insurance on transmissions, An audit log of changes and who made them, why they were made and a report on effect to client security, or which have created increased exposure or hazard to the insurer will be required.

Also a system control file for special information such as: IP Data Insurance's Aggregate Limit, Automatic approval guidelines/rules and Current open insured incidents, and list of all incidents reported during current policy contract period

The policy information will have a very flexible query and reporting capabilities. The system accommodate client who require an “additional insured option”. This is a party or parties that have a liability or may suffer financial loss if the transmission is not delivered and as such may receive the money if a transmission is lost or compromised. For corporations, this will have to be an option that is selected, but the required information to create the additional insured endorsements will be kept with individual filters and past along in the tracking mechanism to identify those transmissions which create special handling in the event of a valid claim.

An example would be a Law firm that makes the transmission receiver the “insured” as the receiver would be the one to incurring the loss, and entitled to payment of the claim if the transmission fails.

The policy history is used to retain historical policy information. It has two prime functions. The first set of policy history is for recent policy changes and it is stored online. It is used to verify claims that took place in the past, attributable to policies that are no longer in effect. (There is a time limit on when claims must be presented, our insurance policies will be “claims made” insurance policies, and claims must be reported within the policy period unless the client opts to purchase “tail” coverage, thus extending the reporting period for coverage.) It will also be used for policy verification of an action when a tracking event or a claim reaches internet protocol Data Insurance after a policy update.

The second use of historical policy information is to warehouse or archive old policy information for historical reasons. This is done when the policy can no longer be used by a customer, no claims are pending on the policy and no new claims can be processed against that policy. This is being stored for historical and regulatory reasons. It is also used for analysis and actuarial research. It is stored from the first set of historical policy information only.

The Audit and Renewal Cycle monitors policy status and claims status and alerts agents when a customer policy should be audited or reviewed. It will be triggered off several different components.

The first trigger will be time. Need to have an audit or renewal process that automatically notifies someone to visit clients to discuss renewal or conduct an audit. Results of audits must be stored and analyzed against policy and actuarial assumptions. Audit results can affect premiums and cause an increase in premiums or a premium reduction. This information will be automatically interfaced to the appropriate financial system.

The second trigger will be usage. If statistics or traffic patterns indicate there is or could be a policy problem this should be proactively reviewed and addressed appropriately by management up.

This component provides the verification criteria required for each policy. These component are used by the customer's modules to verify insurance being applied at the site. It is also used at the internet protocol Data Insurance's tracking site to verify usage. It will also be used by the claims process, as one of the steps needed to authenticate validity of claims.

This functionality will retain running totals against policy usage as it relates to policy assumptions. For example a customer buys insurance to cover 20 documents at $300 of insurance. He tries to insure 21 or he ups the coverage to $1,000 on one document, which lowers the number he can insure—need to track what has been used in this case. There are multiple flavors of this functionality.

Policy Master—This component maintains the policy information pertinent to each customer. This component must have the ability to handle licensees, Master Certificates and all the sub policies changes and endorsements issued under each master. It also maintains the information needed to construct (or reconstruct) an actual policy contract (i.e. requires “generational” views of the policies). When the Policy Generator generates a policy, it is automatically stored in the Policy Master.

Beneficiary—This component maintains information on any beneficiaries related to a policy. This will be used for Provider coverage and possibly individual coverage. What we will need here is an “insured option”. This is a party or parties that have a liability if the transmission is not delivered and as such may receive the money if a transmission is lost. For corporations, this will have to be an option that is selected, but the information is kept with individual filters and passed along in the tracking mechanism.

Risk Assessment Factors—This component maintains information on risk factors and rules on how these factors are used to determine a policy's premium.

Regulatory Authority—This component maintains information on insurance regulatory authorities and the rules required by the authority.

Premium Parameters—This component maintains the business rules and actuary tables used to underwrite policy premiums.

Policy Contract Author—This component maintains all versions of the legal terminology used to generate policies for supported regulatory authorities. It also contains the terminology used to construct special policies and customer terminology written for specific customers. This information must be version controlled with date/time stamp trail—so that older policies can be reconstructed at any time.

Policy Generator—This tool is used by agents to gather the information from a customer needed to create a policy. There will also be a simplified generator for web customers

Customer Installation Package—This component is used to assemble the modules and tables which are downloaded to a customer's site so they can begin to insure transmissions.

Policy History—This component is used to retain historical policy information. It is used to verify claims that took place in the past, against policies that are no longer current. It is also used for analysis and research.

Audit and Renewal Cycle—This component monitors policy status and claims status and alerts agents when a customer policy should be audited or reviewed.

Policy Verification Information—This component provides the verification criteria and components required for each policy. Some of these component are created for the Customer Installation Package and are used by the customer's modules to verify insurance being applied at the customer's site. Similar sets of components are used at the IP Data Insurance's tracking servers to verify usage.

Reinsurance Functionality—The component tracks reinsurance being applied to policies and/or cells.

The Policy Management (Insuring Process) needs to interface with the following systems inputs to other systems, provides information to Accounts Receivable (A/R) for Policy premiums, policy over usage, provides information to Accounts Receivable (A/R) for reinsurance claims, provides information to create/update customer in A/R from Policy Generator, supplies policy parameters used by IP Data Insurance's tracking for verification, creates Installation Package for customer, supplies sales system or creates sales reports, feeds sales approval cycle, feeds Accounts Payable (A/P) for customer adjudicated claims. (vendor required), feeds a sales system or A/P for agents fee (potentially), provides information to A/P for Reinsurance premiums, receives information from other system, gets information from the tracking system on usage, gets agent identification from the sales system, accepts responses from sales approval cycle, tracks downloads of Customer, uses A/R Customer identification and status on existing Customer, checks credit on new Customer A/R or Policy Management (P/M) and receives claims information from the Claims Process

The internet protocol Data Insurance tracking/logging system is consists of two subsystems—a Tracking Insuring System and a Internet Protocol Data Insurance Logging System. The Tracking Insuring System, which creates a tracking record of transmission events and sends those tracking records to a specified server. The internet protocol Data Insurance Logging System receives the tracking event records verifies them and logs them to a database. This document contains a functional description of the Tracking Insuring System.

To provide transmission insurance to its customers, internet protocol Data Insurance requires a “Customer Installation Internet Protocol Data Insuring System” whenever a Policy (contract) is purchased or revised for a customer. The Customer Installation Internet Protocol Data Insuring System will contain all of the components necessary at the customer's site to provide the functionality required to satisfy the provisions of the policy and fulfill Internet Protocol Data Insurance's processing requirements (i.e. transmission tracking).

The system will contain several objects; at a minimum (for initial installations) it will include an: “Installation Program” that installs: the “Policy Profile,” an “Insuring Agent,” the “Category Filter(s)” (usually) one or more, the “Insured Transmission Wrapper” (e.g. a digital certificate), the “Transmission Tracking Agent,” and the “Transmission Insurance Administration” module.

If the customer has a Universal Policy (all transmissions are insured) or a Defined Policy/Rider (specific types or groups of transmissions are insured), at least one Category Filter will be required to identify which transmissions should be insured. The “Wrapper” and Tracking Agent accompany each transmission from the time insurance is applied, until the transmission is completed or fails.

The Tracking Agent bears the responsibility for accompanying each insured transmission “Wrapper” (from initiation through final delivery); tracking and reporting required event information to the customer and IP Data Insurance as defined below. The Wrapper is an intelligent agent (IA) with core component importance in the insuring process. Its presence indicates that the transmission is insured.

The Policy Profile is a data set containing the pertinent elements from the formal policy, which are needed at the customer's site for use by the insuring process (for editing, validation, etc.). This data set will be inserted into the On-site Policy Profile Repository (if no repository exists, it will be created). The Transmission Insurance Administration module is provided to enable the customer to control access to the insuring process and to setup, maintain and test any Category Filters.

For initial installations, the Internet Protocol Data Insuring System must contain the Installation Program, the Insuring Agent, the Insured Transmission “Wrapper” (unique for each policy), the Tracking Agent, the Policy Profile and the Transmission Insurance Administration module.

The inclusion of other components is policy dependent. Each component has been designated as either “on-site” or “traveler”. The “on-site” components reside and operate on the customer's infrastructure and interoperability is highly desirable; “traveler” components accompany the transmission across the Internet and require extensibility and interoperability.

Installation Program—The function of this component is to install Internet Protocol Data Insuring System(s) for initial purchases or policy revisions at the customer's site. This is an on-site component. It must be included in initial and policy revision Internet Protocol

### Data Insurance Systems

Policy Profile—This data set contains the data from the policy necessary for administration and validation of transmission insurance for a specific policy at the customer site. This is an on-site component. It must be included in initial and policy revision Internet Protocol

### Data Insurance Systems

Insuring Agent—This component applies the Insured Transmission Wrapper and all other agents required by the policy to the appropriate message(s). This is an on-site component. It must be included for initial installations and may be included for policy revisions if the Insuring Agent has been updated.

Insured Transmission Wrapper—The Insured Transmission Wrapper is the core component of the insuring process. Its presence indicates that the transmission is insured. Static and dynamic data elements within the wrapper provide the majority of the information needed for the Transmission Tracking Agent to report transmission events. This is a traveler component. It must be included in initial and policy revision Internet Protocol Data Insuring Systems.

Transmission Tracking Agent—This component is responsible for reporting specific transmission events to the customer and/or to an Internet Protocol Data Insurance Transmission Logging server. This function may be handled by a single object, or may require two separate objects (see Functional Requirements). This is a traveler component. It must be included for initial installations and may be included for policy revisions if the Tracking Agent has been updated.

Transmission Insurance Administration—This module provides the customer with the ability to control which personnel within their organization can access/use the various components of the insuring process. The module also contains the functions necessary to define, modify and test any Category Filters, which may be required by their policy. This is an on-site component. It must be included for initial installations and may be included for policy revisions if the Administrative “module” has been updated.

In addition, an Internet Protocol Data Insuring System may also contain one of more of the following components depending on initial policy stipulations and/or policy revisions:

Category Filter—Category Filter(s) are required for Universal policies (in this case, the filter indicates all transmissions are to be insured), and for Defined Transmission Insurance policies or riders to identify the categories of transmissions that are to be insured. This is an on-site component.

Application Plug-in—Application Plug-in(s) are required for Select Transmission Insurance policies or riders to provide the mechanism for the customer to indicate when a message is selected for insured transmission and/or an insured value other than the default value (Typical applications that will require plug-ins are Email, FTP, etc.). This is an on-site component.

Transmission Security Agent—Transmission Security Agent(s) are required to provide any optional transmission security services that a policy may include. Some of these agents may be traveler components.

General Characteristics: All components should be as small, fast and flexible as possible, especially those that accompany the customer's transmissions. We want to avoid adding unnecessary bulk/overhead to the customer's transmissions. If “open source” (e.g. Java) is used, appropriate measures must be employed to protect these proprietary capabilities. All components, which accompany the transmission, must be able to work across all major platforms that are commonly employed on the Internet. Since the Installation Program, Insuring Agents, Category Filters, Plug-ins and the Administration module reside and operate on specific platforms, interoperability is highly desirable, but not absolutely required for these components.

Platforms initially targeted include: DOS: Windows 95/98/NT/2000/Windows XP, OSX & BSD (Apple, Berkeley Standard Development), HP-UX (Hewlett Computer), Sun Solaris, SCO Unix's (Unixware/Openserver/Monterey), IRIX/AIX (SGI/Silicon Graphics, Cray, etc.), IBM's MF OS's (OS/400, OS/390, MVS/ESA, DOS/VSE/ESA), and Linux (RedHat, Open Source, etc.)

In addition to the platforms above, Transmission Tracking Agent(s) will be required to interact with a variety of routers, bridges, switches and/or other network components. Among the major vendors in the “in-flight” components requiring interoperability are: Cisco, 3Com, Bay, Lucent and Juniper Networks.

Although this “in-flight” tracking is a secondary priority, some instances of this type of capability are quite critical (e.g. transmission failure trapping) and reporting capabilities for all defined events are highly desirable. Ideally, this capability could be developed with the “send/receive” tracking. All “traveler” components (i.e. those that accompany the transmission in flight) MUST NOT FAIL!! They must trap unexpected/unknown conditions (and preferably report them) and continue to operate!

Once a new or revised policy has been enrolled and approved, Internet Protocol Data Insurance must be able to automatically (without programming or other human intervention) generate the Customer Installation Internet Protocol Data Insuring System (or update IP Data Insuring Systems for revisions), based on the requirements of that specific customer and policy. Following are the functional definitions of the components that can comprise the Customer Installation IP Data Insuring System:

Installation Program—The function of this component is to install the Internet Protocol Data Insuring System at the customer's site. Its behavior will vary somewhat depending on whether the Internet Protocol Data Insuring System is an initial Installation Internet Protocol Data Insuring System or a Policy Revision Internet Protocol Data Insuring System (i.e. component mix will vary and logic for create/replace/add will vary).

Policy Profile—The function of this component is to transport the critical data from the formal policy to the Policy Profile Repository at the customer's site. When the Internet Protocol Data Insuring System is installed and working, the Policy Profile will either be inserted in an existing Repository, or will trigger the creation of the Repository if one doesn't exist. Within the Repository, Profiles will be flagged as “Pending”, “Active” or “Expired”.

Data elements that may be included in the Profile are: Customer ID, Policy Number (this numbering scheme will include a “revision number”), Policy Type Code, Effective Date, Expiration Date, Annual Aggregate Limit and Category Information (repeats 1-n times). Examples of category information include Category Type Code, Standard (Default) Insured Value, Minimum Insured Value (if applicable), Maximum Insured Value (if applicable), Maximum Monthly Volume, Maximum Transmission Size and Category Options. Examples of category options include Encryption, Non-repudiation Delivery, Data Integrity Monitoring, Registered Receipt, Recipient Password Authentication, Routing Control with Traffic Flow Confidentiality and Point-to-point VPN Security via a web site such as ipdatainsurance.net.

Insuring Agent—The function of this component is to apply the required components to the appropriate transmissions (i.e. those that should be insured).

The Insuring Agent is responsible for updating the Pending/Active/Expired flags for all profiles. This may be accomplished by making a maintenance pass of the Policy Profile Repository daily, or when triggered by a “tickler file” created on a monthly pass. A “tickler file” is an intelligent agent (IA) that audits and reports back any unusual pending/active/expired/issues to the Internet Protocol Data Insurance Policy Profile Repository.

The Insuring Agent can be triggered at one of two points. If the customer has Internet Protocol Data Insurance application plug-ins (i.e. has a Select policy or rider), then the user clicking on the “Insure Button” provided by an applicable plug-in will trigger the Insuring Agent to apply transmission insurance to the “selected” message.

In all other cases (i.e. Universal policies and Defined policies/riders) the Insuring Agent will be triggered by the initiation of transmission (i.e. when the “message” is passed to TCP/IP . . . this will involve a port “sniffer” and plug-in for TCP/IP to invoke the Agent).

Once invoking either method, the Insuring Agent will perform following functions: (1) If triggered by an application plug-in (the user ID, policy number and possibly an insured dollar amount will be passed to the Insuring Agent), apply transmission insurance components to the “selected” message as defined below, and then invoke the normal “send” function of the application. (2) If triggered by TCP/IP (no parameters are passed), determine if transmission insurance has already been applied (i.e. was insured by an application plug-in); if so the Insuring Agent terminates and normal TCP/IP functions continue. (3) Otherwise, the Insuring Agent will test the message against the Category Filter definitions to determine if this transmission should be insured. If the message does not match any of the filters, then the Insuring Agent terminates and normal TCP/IP functions continue. (4) Verify insurability against the Policy Profile Repository (note—the policy number is associated with each Category Filter entry). If an insurability problem is detected, notify the local administrator (and Internet Protocol Data Insurance), log the error on-site and continue or abort the insuring process as specified by the Policy Profile; normal TCP/IP functions continue. (5) Generate a unique Tracking ID. (6) Access the appropriate Insured Transmission Wrapper (for the specific policy), populate the dynamic data fields, and apply the wrapper and appropriate traveler Agents to the message. (7) Log the Tracking ID and basic category/user information in the client site Transmission Log. (8) Normal TCP/IP functions continue.

Insured Transmission Wrapper—This is the basic component of the Internet Protocol Data Insuring System. This component is generated for each policy and should be in some respect unique for that policy (e.g. contain the customer ID/policy number). When generated (at policy approval time), it should be loaded with the effective and expiration dates. This component will accompany all transmissions and will in fact identify the transmission as insured.

Additionally, this component is the carrier (or container) for the Transmission Tracking Agent and any Transmission Security Agent(s) required by the policy. Subject to further detail determination, this component may contain encryption key data (e.g. PKI key info) and/or authentication data (e.g. digital signature, recipient password, etc.) Currently, the following (static and dynamic) data fields have been identified for inclusion in this component. For Provider (or OEM) policies, the customer purchases insurance for the incoming transmissions from his clients.

Examples of Static Data Fields include Customer ID, Policy Number, Policy Type Code, Primary Internet Protocol Data Insurance Transmission Logging Server Internet Protocol Address, Secondary Internet Protocol Data Insurance Transmission Logging Server Internet Protocol Address, Primary Provider Transmission Logging Server Internet Protocol Address (if applicable), Secondary Provider Transmission Logging Server IP Address (if applicable), Insured (beneficiary) ID (if applicable) (this element may need to reside with dynamic data), Effective Date, Expiration Date, Digital Signature(s) (if applicable), Public Key Encryption (if applicable)

Examples of Dynamic Data Fields include Tracking ID, Date/Time Insurance Applied, User/Application ID, Declared Insured Value (if applicable), and Recipient's Password (if applicable).

Transmission Tracking Agent is the component required to enable transmission insurance tracking. The fundamental functions of this component are to transmit transmission event information to an Internet Protocol Data Insurance Transmission Logging Server (a specified IP address) and to a Provider Transmission Logging Server (if applicable).

Each time a transmission event is reported for logging, there will be several standard data fields that will be included in the event report. Additional data elements will be supplied for specific events, as defined below.

The standard data elements may include Event Type Code, Customer ID, Policy Number, Tracking ID, Category ID, Target Internet Protocol Address, Message Size, Data/Time Stamp (of the event) and Internet Protocol Address (of the event).

There are several transmission events that we may need/want logged at the specified Transmission Logging Server. These events and their associated data elements may include: (1) Transmission Initiated—User or Application ID; declared insured value, Insured (beneficiary) ID (if applicable); (2) Router/Gateway Traversed*—(This event must be switch driven, i.e. optional. Switch is enabled/disabled in the wrapper at the customer site.); (3) Transmission Failed*—Failure reason code (NOTE—must know if port address is invalid or data transmission was bounced by a filter/firewall); (4) Transmission Delivered (to recipient server)**; (5) Transmission Tampering Detected**—Condition code (This event must be switch driven, i.e. optional. Switch is enabled/disabled based on the policy profile.) (6) Transmission Received (opened)—User or Application ID (This event must be switch driven, i.e. optional. Switch is enabled/disabled based on the policy profile.) *Reporting of these events may require a separate tracking agent than those reported from the sending and receiving servers.** These events may be combined by adding a condition code to the arrival event.

Transmission Security Agent(s)—This may be one component with multiple functions which may be enabled or disabled as required by the policy, or it may be separate components to supply each of the transmission security provision options offered by Internet Protocol Data Insurance. Transmission Security features that have been identified as potential options at this point are: Encryption, Non-repudiation Delivery, Data Integrity Monitoring: (This area of transmission security would ideally offer two options: detection of in-flight changes to the content, and detection of in-flight “sniffing” of the contents.), Recipient Password Authentication, Registered Receipt, Routing Control with Traffic Flow Confidentiality and Point-to-point VPN Security via IP Data Insurance.net

Category Filter(s)—The purpose of this component is to automatically identify transmissions that should be insured under a Universal Coverage policy or a Defined Coverage policy/rider. A transmission complying with the filter definitions will trigger the application of the Insured Transmission Wrapper and any Agents required by the policy. This component will consist of either the “standard” Category Filter (as defined below) and/or may require a “custom” filter be developed for insured transmission selection criteria not defined within the standard Category Filter. The standard Category Filter will be bundled with a maintenance program that allows the customer's administrator to set-up, modify and test filter definitions. The following types of definitions will be available in the standard filter: messages from specific server(s), Messages from specific sender(s), messages to specific receiver(s), messages between specific sender/receiver pair(s) and message subject-line keyword(s).

Application Plug-in(s)—The purpose of this component class is to provide appropriate applications plug-ins (e.g. e-mail, FTP, etc.) as required for a Select Coverage policy or rider. When installed, the plug-in(s) will add an “insure button” to the relevant application.

The customer will use the insure button (rather than the usual) “initiate transmission button” (e.g. the Send button) to initiate an insured transmission (Note—the number of the policy requiring the plug-in has to be embedded in the plug-in). For all other transmissions, they will continue to use the normal functionality of the application. If the policy allows an insured value range, then the plug-in must display an entry field pre-loaded with the “default” insured value and allow the user to enter an override amount.

Information regarding variable insured values must either be embedded in the plug-in, or (preferably) extracted from the Policy Profile Repository. Initial application products targeted for plug-ins are email applications, FTP applications, streaming data applications, UDP protocols, and wireless TCP protocols.

The email applications may be online, offline or combinations thereof and examples of which include Microsoft Outlook, Microsoft Outlook Express, AOL, Netscape, Lotus Notes, Gmail, Hotmail and Yahoo. The FTP applications may be online, offline or combinations thereof and examples of which include WS-FTP, CuteFTP, Kermit 95, C-Kermit/G-Kermit. The streaming data applications may be online, offline or combinations thereof and examples include RealPlayer, QuickTime, Windows Media Player and Third-Party.

Transmission insuring mechanism external characteristics may vary depending on the application. A flexible mechanism should be employed for the “Insured Transmission Wrapper.” There may be separate tracking agents—sending/receiving platforms—in-flight reporting. If specific IP addresses are embedded in the “Wrapper,” the system may allow the management of any unavoidable changes in these addresses.

The system may specify port numbers for the Tracking Agent to address when reporting to the Transmission Logging Server! We will almost certainly need multiple “catchers” at a Logging Server and we need the highest thru-put we can devise. On CMT, audit messages were sent to one of ten ports, each serving a separate queue, and then the queues were drained to the database by a background process.

We use a TCP/IP plug-in to trigger the Insuring Agent (program), this plug-in will be interoperable, or we will need platform specific plug-ins. Customer ID size will be identified. Policy Number scheme/size. (must include a component to identify revisions).

Logic for generating Tracking ID's if not a straight sequential number. (e.g. server id component as leading portion of tracking id). Application plug-ins (for email, FTP, etc.) somehow “flags” the message rather than directly invoking the Insuring Agent! This would avoid the necessity for the Insuring Agent to recognize that it had already applied the “wrapper,” but may not be viable since we would want to pass the user ID and declared insured value to Insuring Agent. The Categories, Category Filters, their structure, search algorithms, handling multiple filter match priority schema are addressed

One of the unique functions required by Internet Protocol Data Insurance will be to log insured transmission events. Each insured transmission is assigned a “Tracking ID” at the customer's sending server. From the point that an insured transmission is initiated until it is delivered (to the target server), certain events must be reported to and logged on Internet Protocol Data Insurance Transmission Logging Server(s). There will be multiple servers dedicated to this function. Since the Transmission Logging function must be available 24/7, we will require a business continuance strategy for this function such as Storage Area Networks (SANs), local and/or remote server-failover.

These events are logged to provide the audit trail of insurance usage and events as required by a customer's policy and/or internal Internet Protocol Data Insurance business processes. The initiation and delivery events are required in all Internet Protocol Data Insurance policies and these events are always logged. Other transmission events may also be logged, such as the intermediate IP locations that handled the message, or the ID of routers and gateways along the transmissions path. It may also log some security events. These transmission logs will be used as the basis for a “delivery inquiry” by customers. They will also be used by the Claims system to verify non-delivery.

Component Overview of Internet Protocol Data Insurance Transmission Logging System may include a listener, a receiving manager, a logging manager, a logging database, internal process monitoring, delivery monitoring, delivery query and data warehousing.

The listener is a program designed to “listen” at a port for messages being sent to Internet Protocol Data Insurance and then to pass the connection on to a new process, which receives the data. We will probably need multiple Listeners at different ports; ideally the number of Listeners would be dynamically scaleable.

The Receiving Manager is a process designed to receive incoming messages. Forked by the Listener, this component handles receiving the incoming message and storing it on a “persistent queue” for processing by a Logging Manager.

Logging Manager—once a tracking message is received, a Logging Manager will verify it against policy information. If errors or issues are detected, notifications will be sent to the appropriate personnel at Internet Protocol Data Insurance and/or the customer site, and the error is logged along with the related message. If a message is correct—the event is logged in the Internet Protocol Data Insurance Logging Database.

Logging Database is a very robust database where all the current logging information will be stored.

Internal Process Monitoring—all internal processes (Listeners, Receiving Managers and Logging Managers) will be monitored to detect any potential or developing reporting and/or delivery issues. If issues are detected, the appropriate people will be notified.

Delivery Monitoring—the logged (delivery) data will be monitored to detect any potential or developing reporting and/or delivery issues. If issues are detected, the appropriate people will be notified.

Delivery Query—a web site logged into by a customer, phone support telephony, or actual support personnel to inquire about the delivery status of a message.

Data Warehousing—a function to archive transmission-logging information after it is no longer needed on the “current” database.

Functional Requirements of Internet Protocol Data Insurance Transmission Logging System

A Listener is a program designed to “listen” at a local server port for messages being sent to Internet Protocol Data Insurance. The listener establishes a connection with the sending partner. It then creates a socket address and forks a new process (the Receiving Manager). It passes the socket address to the new process and to the sending partner, so that the sending partner and the new process can do the work required to accept the incoming information. This quickly frees the Listener to return to its prime function of listening for new incoming transmissions.

There is usually a limit to the number of processes that a Listener can create. Due to the possibility of very high traffic, we may need a method to create multiple Listeners at different ports and have a method for tracking messages to be directed to these different ports, with a default port always available for failsafe. We may also want to define “classes” (sets) of ports for specific types of traffic. Ideally the number of Listeners would be dynamically scaleable for each defined class. We will also need multiple servers receiving data.

Another reason to create multiple classes (sets) of ports may be to segregate traffic. For example, we may want to have “high dollar” items coming in on a special class of ports to give them operational priority. Another example may be that if we have enabled complete tracking on an item, which reports every router or gateway the message touches, we may want these items to come in via a special class of ports, so that the resulting traffic volume does not interfere with regular traffic.

The receiving Manager is a process designed to receive incoming tracking messages. It will be responsible for accepting these incoming messages and storing them on a “persistent queue” for subsequent processing by a Logging Manager. At this point we envision all Receiving Managers servicing a class (set) of ports writing to a specific “queue”.

Once a tracking message is received (queued), a Logging Manager will verify it against policy information. If errors or issues are detected, notifications will be sent to the appropriate personnel at Internet Protocol Data Insurance and/or the customer site, and the error is logged along with the related message.

The event messages that trigger verification errors may be logged to a different data set.) If message is correct—event is logged in the Internet Protocol Data Insurance Logging Database. Only after the Logging Database has been updated will it be deleted from the queue. The system may need more than one Logging Manager per input queue depending on throughput and volumes.

As data is received and verified, it will be stored in a logging database. This database will have to be very robust because it may be receiving large volumes of data at a very high rate. All the current logging information will be stored in this database.

At this time, we envision several logging tables. One table for send/receive events which are coupled in the database, one for security events, one for detail tracking and one for event messages with verification errors. These are separated to facilitate efficient monitoring.

Since there will be multiple instances of this database (i.e. multiple and/or geographically dispersed Logging Servers), we must either utilize a distributed database, or periodically consolidate these instances into a master Logging Database.

All internal processes (Listeners, Receiving Managers and Logging Managers) will be monitored to detect any potential or developing tracking and/or delivery issues. If issues are detected, the appropriate people will be notified to undertake problem analysis and/or corrective action. Internal process monitoring is responsible for identifying any bottlenecks in the Logging System. (For instance, Internal Process Monitoring may notify the Internet Protocol Data Insurance network administrator that additional Listeners for class x should be activated.)

The logged (delivery) data will be monitored to detect any potential or developing tracking and/or delivery issues. If issues are detected the appropriate people will be notified to undertake problem analysis and/or corrective action. Delivery data monitoring is responsible for identifying persistent delivery problems. (For instance, Delivery Monitoring may notify the Internet Protocol Data Insurance network administrator and the customer's transmission insurance administrator that the customer's traffic to app@xyz.com is experiencing a high failure rate.)

Customers must be able to log into web site or phone support telephony or actual support personnel to inquire about the status of a message. The database inquiry function must be furnished with a Customer ID, a Server Name and a Tracking ID to access the appropriate information. The web interface should supply the Customer ID and Server Name(s) (from the Customer Master database), and the customer must supply the Tracking ID.

A function to archive transmission-logging information after it is no longer needed on the “current” database. This information will be used periodically for various analytical and data mining functions. Due to the large volumes of data anticipated, this will probably require a SAN or clustered DB approach.

Internet Protocol Data Insurance Transmission Logging System External Characteristics requirements include (1) a secure way to identify the incoming messages as valid, (2) “persistence” in conversation between “Tracking Agent” and Receiving Manager, (3) logic in Tracking Agent to “search” its class of ports in order to establish a connection, (4) logic in Tracking Agent to attempt alternate Internet Protocol address if unable to establish a connection on the primary Internet Protocol and (5) logic in Tracking Agent to identify “classes” of ports to be used for types of event reporting.

The Internet Protocol Data Insurance tracking/logging system consists of two subsystems and Tracking Insuring Mechanism and Internet Protocol Data Insurance Logging System. The Tracking Insuring Mechanism, which creates a tracking record of transmission events and sends those tracking records to a specified server. The Internet Protocol Data Insurance Logging System which receives the tracking event records, verifies them and logs them to a database. This document contains functional description of the Insurance Logging System.

One of the unique functions required by Internet Protocol Data Insurance is the logging of insured transmission events. Each insured transmission is assigned a “Tracking ID” at the customer's sending server. At that point the insured transmission is initiated until it is delivered (to the target receiving server), certain events must be reported to and logged on Internet Protocol Data Insurance (approved) Transmission Logging Server(s).

There will be multiple servers dedicated to this function. Since the Tracking-Logging function must be available 24/7, we employ a business continuity strategy for this function such as Storage Area Networks (SANs), and local and/or remote server fail-over. The system may include redundancy throughout the process.

These events are logged to provide the “audit trail of insurance” usage and events as required by a customer's policy and/or internal Internet Protocol Data Insurance business processes. The initiation and delivery events are required in all Internet Protocol Data Insurance policies and these events are automatically logged. Other transmission events may also be logged, and recorded such as the intermediate Internet Protocol locations that handled the message, or the ID of routers and gateways along the Tracking path. It also logs insured security events for forensic examination

These transmission logs will be used as the basis for a “delivery inquiry” by customers. They will also be used by the Claims System to verify transit time-date stamp, TCP/IP environmental history, travel activity and non-delivery.

Listener—a listener is a program designed to “listen” at a port for messages being sent to Internet Protocol Data Insurance and then to pass the connection on to a new process, which receives the data. We require multiple Listeners at multiple different ports; ideally the number of Listeners would be dynamically scaleable.

Receiving Manager—is a process designed to receive incoming messages? Forked by the Listener, this component handles receiving of the incoming message and storing it in a “persistent queue” for processing by a Logging Manager.

Logging Manager—once a tracking message is received, a Logging Manager will verify TCP store-forward header data against policy information. If errors or issues are detected, notifications will be sent to the appropriate personnel at Internet Protocol Data Insurance and/or the customer site, and the error is logged along with the related message. If a message is correct—the event is logged in the Internet Protocol Data Insurance Logging Database.

Logging Database—a scaleable, robust database where ALL current log information will be stored. The logging data base features multiple redundancies

Internal Process Monitoring—all internal processes (Listeners, Receiving Managers and Logging Managers) will be monitored to detect any potential developing or delivery reporting issues. If issues are detected, the appropriate automated data insuring systems will be notified.

Delivery Monitoring—the logged (delivery) data will be monitored to detect any potential or developing reporting and/or delivery issues. If issues are detected, the appropriate people will be notified for immediate corrective action.

Delivery Query—a web site logged into by a customer, phone support telephony, or actual support personnel to inquire about the delivery status of a message.

Data Warehousing—a function to archive transmission-logging information after it is no longer needed on the “current” database. Warehoused data is held and stored on redundant servers at multiple locations.

Listener—A Listener is a program designed to “listen” at a local server port for messages being sent and received that involve Internet Protocol Data Insurance. The listener establishes a connection with the sending partner, the logging database(s) for the store-forward TPA (third party administrator) requirements and the redundant fail-over logging database for forensics, for back-up and other yet-to-be determined unknowns. It then creates a socket address and forks a new process (the Receiving Manager). It passes the socket address to the new process and to the sending partner, so that the sending partner and the new process can do the work required to accept the incoming information. This quickly frees the Listener to return to its prime function of listening for new incoming transmissions.

There is usually a limit to the number of processes that a Listener can create. Due to the possibility of very high traffic, we can create multiple Listeners at different ports for tracking messages to be directed to these ports, with a default port always available for failsafe operation. We may also want to define “classes” (sets) of ports for specific types of traffic. Ideally the number of Listeners will be dynamically scaleable for each defined class. We will also employ multiple servers receiving data.

Another reason to create multiple classes (sets) of ports may be to segregate traffic. For example, we may want to have “high value” items coming in on a special class of ports to give them operational priority. Another example may be that if we have enabled complete tracking on an item, which reports every router or gateway the message touches, we may want these items to come in via a special class of ports, so that the resulting traffic volume does not interfere with regular traffic.

2b) Receiving Manager—The receiving Manager receives incoming tracking messages. It is responsible for accepting these incoming messages and storing them on a “persistent queue” for subsequent processing by a Logging Manager. All Receiving Managers service a class (set) of ports writing to specific “queues”.

2a-3b) Logging Manager—when a tracking message is received (queued), a Logging Manager will verify it against policy information. If errors or issues are detected, notifications are sent to the appropriate personnel at Internet Protocol Data Insurance and/or the customer site, and the error is logged along with the related message. The event messages that trigger verification errors may be logged to a different data set. If message is correct—event is logged in the Internet Protocol Data Insurance Logging Database. Only after the Logging Database has been updated will it be deleted from the queue. The system may deploy more than one Logging Manager per input queue depending on throughput and volumes.

Logging Database—when data is received and verified, it will be stored in a logging database. This database is very robust because it may be receiving large volumes of data at a very high rate. All the current logging information will be stored in this database. This data base also features multiple redundancies.

It is possible for there to be multiple logging tables. One table for send/receive events which are coupled in the database, one for security events, one for detail tracking and one for event messages with verification errors. These are separated to facilitate efficient monitoring. Since there will be multiple instances of this database (i.e. multiple and/or geographically dispersed Logging Servers), the system may utilize a distributed database, or periodically consolidate these instances into a master Logging Database.

5) Internal Process Monitoring—All internal processes (Listeners, Receiving Managers and Logging Managers) will be monitored to detect any potential or developing tracking and/or delivery issues. If issues are detected, the appropriate personnel will be notified to undertake problem analysis and/or corrective action. Internal process monitoring is responsible for identifying any bottlenecks in the Logging System. For instance, Internal Process Monitoring may notify the IP Data Insurance network administrator that additional Listeners for class x should be activated.

2b) Delivery Monitoring—The logged (delivery) data is monitored to detect any potential or developing tracking and/or delivery issues. If issues are detected the appropriate personnel will be notified to undertake problem analysis and/or corrective action. Delivery data monitoring is responsible for identifying persistent delivery problems. For instance, Delivery Monitoring will notify the IP Data Insurance network administrator and the customer's transmission insurance administrator that the customer's traffic to app xyz.com is experiencing a high failure rate.

1a, 1b, 1c) Delivery Query—Customers will be able to log into a web site or phone support telephony or actual automated computer support to inquire about the status of a message. The database inquiry function shall be furnished with a Customer ID, a Server Name and a Tracking ID to access the appropriate information. The web interface will supply the Customer ID and Server Name(s) (from the Customer Master database), and the customer must supply the Tracking ID.

2a) Data Warehousing—A function to archive transmission logging information after it is no longer needed on the “current” database. This information will be used periodically for various analytical and data mining functions. Due to the large volumes of data anticipated, this will probably require a SAN or clustered DB approach.

Once a new or revised policy has been enrolled and approved, IP Data Insurance The system will automatically (without programming or other human intervention) generate the Customer Installation IP Data Insuring System (or update IP Data Insuring Systems for revisions), based on the requirements of that specific customer and policy. Following are the functional definitions of the components that can comprise the Customer Installation IP Data Insuring System:

Installation Program—The function of this component is to install the IP Data Insuring System at the customer's site. Its behavior will vary somewhat depending on whether the IP Data Insuring System is an initial Installation IP Data Insuring System or a Policy Revision IP Data Insuring System (i.e. component mix will vary and logic for create/replace/add will vary).

Policy Profile—The function of this component is to transport the critical data from the formal policy to the Policy Profile Repository at the customer's site. When the IP Data Insuring System is installed and operational, the Policy Profile will either be inserted in an existing Repository, or will trigger the creation of the Repository if one doesn't exist. Within the Repository, Profiles will be flagged as “Pending”, “Active” or “Expired”. Data elements currently identified for inclusion in the Profile are: Customer ID6, Policy Number (this numbering scheme will include a “revision number”), Policy Type Code, Effective Date, Expiration Date, Annual Aggregate Limit and Category Information (repeats 1-n times),

Examples of the category information includes Category Type Code, Standard (Default) Insured Value, Minimum Insured Value (if applicable), Maximum Insured Value (if applicable), Maximum Monthly Volume, Maximum Transmission Size and Category Options.

Examples of the category options include Encryption, Non-repudiation Delivery, Data Integrity Monitoring, Registered Receipt, Recipient Password Authentication, Routing Control with Traffic Flow Confidentiality and Point-to-point VPN Security via a web site such as ipdatainsurance.net.

Insuring Agent—The function of this component is to apply the required components to the appropriate transmissions (i.e. those that should be insured).

The Insuring Agent is responsible for updating the Pending/Active/Expired flags for all profiles. This may be accomplished by making a maintenance pass of the Policy Profile Repository daily, or when triggered by a “tickler file” created on a monthly pass.

The Insuring Agent can be triggered at one of two points. If the customer has Internet Protocol Data Insurance application plug-ins (i.e. has a Select policy or rider), then the user clicking on the “Insure Button” provided by the applicable plug-in will trigger the Insuring Agent to apply transmission insurance to the “selected” message.

In all other cases (i.e. Universal policies and Defined policies/riders) the Insuring Agent will be triggered by the initiation of transmission (i.e. when the “message” is passed to TCP/IP . . . this will involve a port “sniffer” and plug-in for TCP/IP to invoke the Agent).

Once invoking either method, the Insuring Agent will perform following functions. If triggered by an application plug-in (the user ID, policy number and possibly an insured dollar amount will be passed to the Insuring Agent), apply transmission insurance components to the “selected” message as defined below, and then invoke the normal “send” function of the application. If triggered by TCP/IP (no parameters are passed), determine if transmission insurance has already been applied (i.e. was insured by an application plug-in); if so the Insuring Agent terminates and normal TCP/IP functions continue.

Otherwise, the Insuring Agent will test the message against the Category Filter definitions to determine if this transmission should be insured. If the message does not match any of the filters, then the Insuring Agent terminates and normal TCP/IP functions continue.

The following steps embody the actual insuring process. Verify insurability against the Policy Profile Repository (note—the policy number is associated with each Category Filter entry). If an insurability problem is detected, notify the local administrator (and Internet Protocol Data Insurance), log the error on-site and continue or abort the insuring process as specified by the Policy Profile; normal TCP/IP functions continue.

Generate a unique Tracking ID. Access the appropriate Insured Transmission Wrapper (for the specific policy), populate the dynamic data fields, and apply the wrapper and appropriate traveler Agents to the message. Log the Tracking ID and basic category/user information in the client site Transmission Log. Normal TCP/IP functions continue.

Insured Transmission Wrapper—This is a basic component of the Internet Protocol Data Insuring System. This component is generated for each policy and is unique for that policy (e.g. contain the customer ID/policy number). When generated (at policy approval time), it should be loaded with the effective and expiration dates. This component will accompany all transmissions and will in fact identify the transmission as insured.

Additionally, this component is the carrier (or container) for the Transmission Tracking Agent and any Transmission Security Agent(s) required by the policy. Subject to further detail determination, this component will contain encryption key data (e.g. PKI key info) and/or authentication data (e.g. digital signature, recipient password, etc.) Currently, the following (static and dynamic) data fields have been identified for inclusion in this component. For Provider (or OEM) policies, the customer purchases insurance for the incoming transmissions from his clients.

Static Data Fields may include Customer ID, Policy Number, Policy Type Code, Primary IP Data Insurance Transmission Logging Server Internet Protocol Address, Secondary Internet Protocol Data Insurance Transmission Logging Server Internet Protocol Address, Primary Provider Transmission Logging Server IP Address (if applicable), Secondary Provider Transmission Logging Server Internet Protocol Address (if applicable), Insured (beneficiary) ID (if applicable) (this element may need to reside with dynamic data), Effective Date, Expiration Date, Digital Signature(s) (if applicable), Public Key Encryption (if applicable) and other or alternative encryption techniques or security features.

Dynamic Data Fields may include Tracking ID, Date/Time Insurance Applied, User/Application ID, Declared Insured Value (if applicable) and Recipient's Password (if applicable) 11.

Transmission Tracking Agent—This is the component which enables transmission insurance tracking. The fundamental functions of this component are:

To transmit transmission event information to an Internet Protocol Data Insurance Transmission Logging Server (a specified Internet Protocol address) and to a Provider Transmission Logging Server (if applicable)

Each time a transmission event is reported for logging, there will be several standard data fields that will be included in the event report. Additional data elements will be supplied for specific events, as defined below.

The standard data elements may include Event Type Code, Customer ID, Policy Number, Tracking ID, Category ID, Target IP Address, Message Size, Data/Time Stamp (of the event) and IP Address (of the event).

There are several transmission events that will be logged at the specified Transmission Logging Server. These events and their associated data elements are: (1) Transmission Initiated—User or Application ID; declared insured value, Insured (beneficiary) ID (if applicable); Router/Gateway Traversed*—(This event must be switch driven, i.e. optional. Switch is enabled/disabled in the wrapper at the customer site.); (3) Transmission Failed*—Failure reason code (NOTE—must know if port address is invalid or data transmission was bounced by a filter/firewall); (4) Transmission Delivered (to recipient server)**; (5) Transmission Tampering Detected**—Condition code (This event must be switch driven, i.e. optional. Switch is enabled/disabled based on the policy profile.); (6) Transmission Received (opened)—User or Application ID (This event must be switch driven, i.e. optional. Switch is enabled/disabled based on the policy profile.) * Reporting of these events may require a separate additional tracking agent than those reported from the sending and receiving servers.** These events may be combined by adding a condition code to the arrival event.

Transmission Security Agent(s)—This component with multiple functions which will be enabled or disabled as required by the policy, or it may consist of separate components to supply each of the transmission security provision options offered by IP Data Insurance. Transmission Security features that have been identified as potential options at this point include: (1) Encryption—Non-repudiation Delivery; (2) Data Integrity Monitoring: (This area of transmission security would ideally offer two options: detection of in-flight changes to content, and detection of in-flight “sniffing” of the contents.); (3) Recipient Password Authentication; (4) Registered Receipt; (5) Routing Control with Traffic Flow Confidentiality; (6) Point-to-point VPN Security via a web site such as ipdatainsurance.net.

Category Filter(s)—The purpose of this component is to automatically identify transmissions that are insured under a Universal Coverage policy or a Defined Coverage policy/rider. A transmission complying with the filter definitions will trigger the application of the Insured Transmission Wrapper and any Agents required by the policy. This component consists of either the “standard” Category Filter (as defined below) and/or may require a “custom” filter be developed for insured transmission selection criteria not defined within the standard Category Filter. The standard Category Filter is bundled with a maintenance program that allows the customer's administrator to set-up, modify and test filter definitions.

The following types of definitions may be available in the standard filter: Messages from specific server(s), Messages from specific sender(s), Messages to specific receiver(s), Messages between specific sender/receiver pair(s) and Message subject-line keyword(s).

Application Plug-in(s)—The purpose of this component class is to provide appropriate applications plug-ins (e.g. e-mail, FTP, etc.) as required for a Select Coverage policy or rider. When installed, the plug-in(s) will add an “insure button” to the relevant application.

The customer will use the insure button (rather than the usual “initiate transmission button” (e.g. the Send button) to initiate an insured transmission. The number of the policy requiring the plug-in has to be embedded in the plug-in. For all other transmissions, they will continue to use the normal functionality of the application. If the policy allows an insured value range, then the plug-in must display an entry field pre-loaded with the “default” insured value and allow the user to enter an override amount.

Information regarding variable insured values will be either be embedded in the plug-in, or (preferably) extracted from the Policy Profile Repository.

The Claims Management System is used to track and manage claims reported and filed against IP Data Transmission Insurance policies. It will track ALL claims activity, from the initial filing through claims settlement, and record and allocate claims settlement costs and expenses.

Claims Initiation Process—capture first notice of loss from insureds and open claims file after automatic authentication of claim and verification of coverage against active police bordereau.

Claims Verification and Approval Process—When claim has been authenticated and accepted by policy manager, approval is granted to accept the claim, and assign appropriate resource to examine claim, apply forensic tools to identify source and cause of loss preliminarily, and assign claim adjuster to further investigate occurrence, and work to resolve or pay claim for insured policy holder

Claims Payment Process—upon completion of investigation of loss, validation of coverage against policy standards, and forensic review to determine if all policy warranty provisions have been satisfied, claim is placed in payment queue, and reinsurers are notified via their respective borderaus if payment will be required by them under their reinsurance contract.

Claims Dispute Process—Customer claims disputes and problems are handled via an arbitration process for small claims that fall outside of policy terms, or if there is a material deficiency in the policy holders warranted terms to arrive at payment for policy holder. Larger claims require a similar but more exhaustive review of the incident, the actual loss sustained by the insured, and the agreement on settlement terms with reinsurers.

Insurer will pay a claim on any insured Internet transmission that fails, and creates a valid liability, assuming the following are met: (1) The claim is not invalid due to policy exclusions, violation of policy conditions or failure to maintain features warranted to be present at the time coverage is bound, or that arise from the neglect of the insured to maintain adequate loss prevention safeguards agreed to as a condition for offering coverage to the insured; (2) There is no detected pattern of fraud, undisclosed moral hazards in offering insurance coverage, or criminal intent to harm the insurer; and (3) The Customer's claim does not exceed policy limits, either per occurrence, or aggregate, nor violate policy guidelines.

Corporate intends to be a Customer centric business and as such, requires that the claims processing be readily available and highly automated for Customers use and that its operation be “customer friendly”. All Customer contact will be logged and pertinent information be passed to assigned claim investigator and claim adjuster who has personal contact with the Customer. All claim information is stored as part of the company's data base, to be applied to future rate making. Actuarial and security analysis as well as becoming a component of the clients audit trail

Historically, claims processing has been a very “people” intensive process and thus a very expensive process for insurance companies. Some of the “people” contact is required by regulations. For example, claims adjusters are certified and or licensed in the domicile in which they are providing claim adjustment service, and are the final authority on the claims disposition. In order to minimize this expense and maximize service, automation, smart forms, and other means are applied to as great an extent as possible to expedite the process's to swiftly bring a claim to its conclusion.

The claims process is the same for all types of coverage—Universal, Defined or Select. In future product rollouts, claims processing will be a multilingual service reflecting the global nature of the insured product.

When a Corporate Customer files a claim, they have four options. They may use corporate web-based claims portal to file a claim automatically—or—use email, fax or Corporate Customer phone support process.

Claims management system captures the initial claim information and submits it for verification to the policy management system. The initial claim information can be captured using one of the following methods:

A first notice of loss can be submitted via the corporate website, phone, e-mail, or fax. Although the procedures vary by media, the business process is the same. When a claim is filed the following processes must occur:

The claimant must supply claim information (via one of the above media) that contains at least the following: Policy ID, transmission ID, transaction ID, and tracking ID number, Customer ID (if possible), Customer Name, and signature (or e-signature, if filed electronically), The tracking ID of the transmission(s) to which the claim is being made, Date and time of loss and Amount of claim.

A claim number will be assigned to the claim and the data will be stored electronically. Corporate plans to provide different media through which a claim can be made. This allows the Customer more flexibility and access to corporate claims processing. It also allows Corporate to automate the process of securing claims information from the Customer and reduce claims adjusters time requirements.

Note on multiple media, the system may charge for filing a claim but charge less if they use the web-site with little human intervention required. The web-site procedure is as follows: (1) The browser-based claim submittal is delivered via as a secure URL web claim form. A Customer using it provides the required “claim request information”—Customer ID#, tracking ID#, contact info; (2) The “Claim Request” form can populate certain required fields from Customer ID and Tracking ID information; (3) The claim form is designed to facilitate printing; (4) The Customer support phone system will use telephony (or personnel) to gather as much information as possible, such as Customer ID and Message tracking ID. These will be entered into the same claims process; and (5) A person can send a fax or an e-mail containing the Customer ID, Customer name, Policy ID and Tracking ID. These will be entered into the same claims process.

Once the initial loss notification is obtain, the claim must be analyzed to determine its validity. This analysis results in a recommendation to the claims adjuster on how a claim should be settled.

After a claim number is assigned and valid identification information is obtained, a process is required to validate the claim and to make a recommendation to the claims adjuster as to the claims disposition. The claim is validated against the policy in effect at the time of the transmission.

A denial recommendation will be made, if any of the following conditions occur: (1) the tracking database indicates the message was delivered, (2) the claim exceeds the policy limits, (3) the claim is outside policy parameters, (4) the claim falls under policy exclusions, and (5) the policy is in arrears

If the claim appears valid, the claim will be analyzed against fraud detection patterns. If the patterns indicate fraud, the claim will be marked for investigation. If no fraud pattern is detected, an approval recommendation is made for the claim. A notification is created for a claims adjuster listing the claim's recommendation.

The claims adjuster will review the notification and make the final determination. If the claim is denied, written notice of the denial and reasons will be provided to the Customer. Information on how to access dispute procedures should also be supplied to the Customer. If claims are to be investigated, the claims adjuster will initiate that functionality. Note: some claims that are recommended for approval, should occasionally be selected for investigation by the adjuster. If the claim is approved, the insured will be notified of the approval.

Once a claim is approved a business process is needed to insure that the Customer signs a claim form before payment is finalized. To finalize a claim, it may be necessary for the Customer sign a claim form. In some cases the system will require that the form be mailed to Corporate. This is done because using the postal service adds an extra measure of protection for Corporate against fraud. If someone mails a fraudulent claim through the mail, they are also perpetrating a mail fraud, which is a very serious offense.

The verbiage on the claim form should inform the insured about the seriousness of mail fraud. We will use table driven mechanism to determine which claims must be signed and mailed to us. Some possible candidates for the mail requirement are: Any claims that have been investigated or have any indicators of questionable activity, claims over a set dollar value, Multiple claims from a single entity and claims filed over the phone.

Other Customers, whose claims do not require using the postal service, may file their claim form via the web-site, fax or e-mail. The web-site and e-mail forms can be signed using an e signature or a digital signature on the claim form and returned via those media. The claims can also be printed, signed and faxed to Corporate.

Once the claim form is returned, the claim status is updated to approve and the payment process is initiated. A claim payment interface is created and fed to the accounts Payable (A/P) system. Once the claim is paid an interface should be returned from Accounts Payable that contains the claim number, date paid and check number. This information should update the claims record and change the claim status to closed.

If the approved claim affects re-insurance, that information is also updated and the re-insurer(s) are notified of the claim and an accounting interface is created as per the re-insurers agreement. Note: re-insurers can employ many different method of paying a claim. For example, they may actually pay the claim, in which case an interface to Accounts Receivable would be required. They may prefer to pass on a reduction of their premium, in which case an interface to Accounts Payable and to the re-insurance master may be required. Flexible reporting and query facilities are required

A system to manage claims disputes will provide the claims arbitrators with Customer and claim information from the claims audit log. They will use this information to resolve claims that are in dispute. This function will retain an audit log of all Customer contact activity and claim resolutions.

The claims arbitrator will receive input from Customers, via the web site, email, fax or phone. All contact with the client will be logged. Final resolution of the claim will be made and handled via the same processes available to the claims adjuster. Once resolution is made, it is entered into the claims system and all subsequent processing is handled automatically.

Need to interface with the following systems: Feeds to other systems, Pass information to Accounts Receivable (A/P) for approved claims payments, Pass information to Accounts receivable (A/R) for reinsurance billing, Possibly pass information to A/P for reinsurance premium adjustments, Pass information to the reinsurance module?, Information from other system, Get information from the tracking system on usage, Customer information from Customer master, Reinsurance information, Get information from A/P on payment status, Get information on Customer contact history and Customer Policy master information.

The following exclusions apply: (1) transmissions sent to the wrong recipient do not constitute non-delivery, (2) transmissions logged by Corporate as “received.” (3) if Corporate has proof that the transmission was delivered then non-delivery cannot be claimed, (4) if the Sender's internal server fails to initiate the transmission, (5) if the recipient server rejects the transmission because it is off-line or the transmission violates security policy, or other recipient server operational policies, (6) transmissions that violate the Customer's insurance contract, and (7) transmissions that do not comply with the Customer's Policy Conditions such as Acts of Fraud or Acts of terrorism—or—war. Endorsements can be added to accommodate a Customer's desire to apply insurance coverage to events that are normally not covered.

It is contemplated that features disclosed in this application, as well as those described in the above applications incorporated by reference, can be mixed and matched to suit particular circumstances. Various other modifications and changes will be apparent to those of ordinary skill.

1. An electronic transmission insurance method comprising:
associating a customer installation module with a first computer client;
preparing an electronic transmission on the first computer client that is addressed to a second computer client that is distinct from the first computer client;
generating an electronic transmission identifier with the customer installation module;
associating the electronic transmission identifier with the electronic transmission;
transmitting the electronic transmission from the first computer client;
transmitting the electronic transmission identifier from the first computer client to a network server to indicate that the electronic transmission has been sent by the first computer client;
creating an insurance policy relating to the electronic transmission;
receiving the electronic transmission by the second computer client; and
processing a claim pursuant to the terms of the insurance policy if the network server does not receive the electronic transmission identifier from the second computer client indicating that the electronic transmission has been received by the second computer client.

2. The method of claim 1, wherein an insurance policy is created for all electronic transmissions transmitted from the first computer client.

3. The method of claim 1, wherein insurance policies are created for only selected electronic transmission transmitted from the first computer client.

4. The method of claim 1, and further comprising transferring data relating to the transmission of the electronic transmission identifier from the first computer client and the transmission of the electronic transmission identifier from the second computer client to a data warehouse.

5. The method of claim 4, wherein the data is periodically transferred to the data warehouse.

6. The method of claim 4, and further comprising transferring data from the data warehouse to a third party administrator.

7. The method of claim 6, and further comprising generating a summary of the data before transferring the data from the data warehouse to the third party administrator.

8. The method of claim 6, wherein the data is periodically transferred from the data warehouse to the third party administrator.

9. The method of claim 6, and further comprising transferring data from the third party administrator to a captive reinsurer.

10. The method of claim 9, and further comprising generating a summary of the data before transferring the data from the third party administrator to the captive reinsurer.

11. The method of claim 9, wherein the data is periodically transferred from the third party administrator to the captive reinsurer.
